(19) United States
(12) Patent Application Publication
(10) Pub. No.: US 2013/0068725 A1
(43) Pub. Date: Mar. 21, 2013

(54) METHOD OF PRODUCING POROUS GLASS

(71) Applicants: Kenji Takashima, Tokyo (JP); Zuyi Zhang, Yokohama-shi (JP); Yoshinori Kotani, Yokohama-shi (JP)

(72) Inventors: Kenji Takashima, Tokyo (JP); Zuyi Zhang, Yokohama-shi (JP); Yoshinori Kotani, Yokohama-shi (JP)

(73) Assignee: CANON KABUSHIKI KAISHA, Tokyo (JP)

(21) Appl. No.: 13/700,068

(22) PCT Filed: May 20, 2011
(86) PCT No.: PCT/JP2011/062151

§ 371 Date: Nov. 26, 2012

(30) Foreign Application Priority Data
Jun. 1, 2010 (JP) 2010-126329

(51) Int. Cl. C03C 15/00

(52) U.S. Cl. CPC C03C 15/00
USPC 216/56

(57) ABSTRACT

Provided is a method of producing a porous glass, including selectively etching a phase-separated glass with an acid solution, in which the method allows a processing time to be shortened and suppresses gel-like silica from remaining and being deposited in pores of a porous portion. The method of producing a porous glass includes: immersing the phase-separated glass in a bath containing an acid solution; setting an angle θ, which is formed by a surface to be porosified of the phase-separated glass and a bath liquid surface, to 10° or more to 90° or less; and irradiating the bath with an ultrasonic wave to etch the phase-separated glass, thereby obtaining the porous glass.

### TECHNICAL FIELD

The present invention relates to a method of producing a porous glass, and more particularly, to a method of producing a porous glass including selectively etching a phase-separated glass with an acid solution while irradiating the phase-separated glass with an ultrasonic wave.

### BACKGROUND ART

The production of a porous glass utilizing a phase separation phenomenon is generally performed by inducing a phase separation phenomenon by heat treatment of holding a molded glass at high temperature for a long period of time, and etching the glass with an acid solution to elute a silica-poor phase. A skeleton of the porous glass is mainly formed of silicon oxide. In the method of producing a porous glass utilizing a phase separation phenomenon, a borosilicate glass mainly containing silicon oxide, boron oxide, and an alkali metal oxide is used as a starting material.

A glass, in which a phase separation is induced by holding the glass at high temperature for a long period of time (hereinafter, referred to as “phase separation heat treatment”) is called a phase-separated glass. A porous glass is obtained by selectively etching the phase-separated glass with an acid solution. In general, it takes 1 day or more to carry out the etching. In addition, gel-like silica may be deposited and remain in pores of the porous glass obtained after the etching.

NPL 1 discloses a method of suppressing the deposition of gel-like silica, for example, by changing the concentration of an acid so as to remove the gel-like silica. However, a glass may crack depending upon the concentration of an acid.

Further, PTL 1 discloses a method of applying an ultrasonic wave to a glass substrate when etching the glass substrate with hydrofluoric acid, thereby removing a reaction product generated during the etching from the glass substrate. However, the diameter of pores of a porous product obtained by a phase separation phenomenon is several nm to hundreds of nm, and there is no disclosure of a method of accelerating the removal of gel-like silica or preventing gel-like silica from remaining and being deposited in that area. Further, the handling of hydrofluoric acid used in this method is not easy.

### CITATION LIST

### Patent Literature

PTL 1: Japanese Patent Application Laid-Open No. 2004-190043

### Non Patent Literature

NPL 1: “New glass and physical properties thereof”, chapter 2, page 51, edited by Tetsuro Izumitani

### SUMMARY OF INVENTION

### Technical Problem

The present invention has been made in order to solve the above-mentioned problem. An object of the present invention is to provide a method of producing a porous glass, including selectively etching a phase-separated glass with an acid solution, in which the method allows a treatment time to be shortened and suppresses gel-like silica from remaining and being deposited in pores of a porous portion.

### Solution to Problem

In order to solve the above-mentioned problem, according to the present invention, a method of producing a porous glass includes: immersing a phase-separated glass in a bath containing an acid solution; setting an angle θ, which is formed by a surface to be porosified of the phase-separated glass and a bath liquid surface, to 10° or more to 90° or less; and irradiating the bath with an ultrasonic wave to etch the phase-separated glass, thereby obtaining the porous glass.

### Advantageous Effects of Invention

According to the present invention, there can be provided the method of producing a porous glass by etching a phase-separated glass with an acid solution, in which the method allows a treatment time to be shortened and suppresses gel-like silica from remaining and being deposited in pores of a porous portion.

Further features of the present invention will become apparent from the following description of exemplary embodiments with reference to the attached drawings.

### BRIEF DESCRIPTION OF DRAWINGS

FIG. 1 is a schematic view illustrating one embodiment of a method of producing a porous glass according to the present invention.

FIGS. 2A and 2B are electron micrographs of a fractured surface of a porous glass produced in Example 1.

FIGS. 3A and 3B are electron micrographs of a fractured surface of a porous glass produced in Example 2.

FIG. 4 is an electron micrograph of a fractured surface of a porous glass produced in Comparative Example 1.

FIGS. 5A and 5B are electron micrographs of a fractured surface of a porous glass produced in Comparative Example 2.

### DESCRIPTION OF EMBODIMENTS

Hereinafter, one embodiment for carrying out the present invention is described.

According to the present invention, a method of producing a porous glass includes: immersing the phase-separated glass in a bath containing an acid solution; setting an angle θ, which is formed by a surface to be porosified of the phase-separated glass and a bath liquid surface, to 10° or more to 90° or less; and irradiating the bath with an ultrasonic wave to etch the phase-separated glass, thereby obtaining the porous glass.

A known material for producing a porous glass utilizing a phase separation phenomenon is, for example, a borosilicate glass mainly containing silicon oxide, boron oxide, and an alkali metal oxide and serving as a starting material. In general, the borosilicate glass is expressed in a weight ratio in terms of SiO₂, B₂O₃, and M₂O (M is an alkali metal element).

A borosilicate glass having a particular composition undergoes a phase separation phenomenon in which a glass is separated into a silicon oxide glass phase mainly containing silicon oxide and a borosilicate glass phase mainly containing boron oxide and an alkali metal oxide in the course of the application of heat. A glass that has undergone the phase separation phenomenon is referred to as phase-separated glass in this specification. A phase-separated borosilicate glass is, for example, an SiO₂ (55 to 80% by weight)-B₂O₃—Na₂O—(Al₂O₃)-based glass, an SiO₂ (35 to 55% by weight)-B₂O₃—Na₂O-based glass, an SiO₂—B₂O₃—CaO—Na₂O—Al₂O₃-based glass, an SiO₂—B₂O₃—Na₂O—RO (R: alkaline earth metal, Zn)-based glass, and an SiO₂—B₂O₃—CaO—MgO—Na₂O—Al₂O₃—TiO₂ (TiO₂ is contained up to 49.2 mol %) borosilicate glass.

The phase separation phenomenon is generally expressed when a glass is held at a temperature of about 500° C. to 700° C. for several hours to tens of hours. This heating is referred to as phase separation heating in this specification. In a particular composition, phase-separated glass may be obtained even without the phase separation heating. Depending upon the temperature and retention time, or the combination of heat treatment profiles, the state of expression of phase separation changes, and further, the pore size and pore density at a time when a porous glass is obtained change.

Regarding a borosilicate glass as a phase-separated glass that has undergone a phase separation, a borate glass phase mainly containing boron oxide and an alkali metal oxide is soluble in an acid solution. Thus, the soluble phase reacts by acid treatment, and only a silicon oxide glass phase mainly containing silicon oxide remains as a skeleton to form a porous product. This corresponds to selective etching.

The selective etching with an acid solution generally takes a long period of time such as several hours to tens of hours. Further, even when a soluble phase that is a borate glass phase mainly containing boron oxide and an alkali metal oxide is eluted by the selective etching, gel-like silica may remain and be deposited in pores.

As a method of suppressing the deposition of gel-like silica, a method of adjusting the concentration of an acid solution is considered. However, if the concentration of an acid is increased excessively, there is an increased risk that a glass cracks during etching. On the other hand, if the concentration of an acid is decreased excessively, the reaction between the acid and the soluble phase does not proceed smoothly, which decreases an etching speed remarkably.

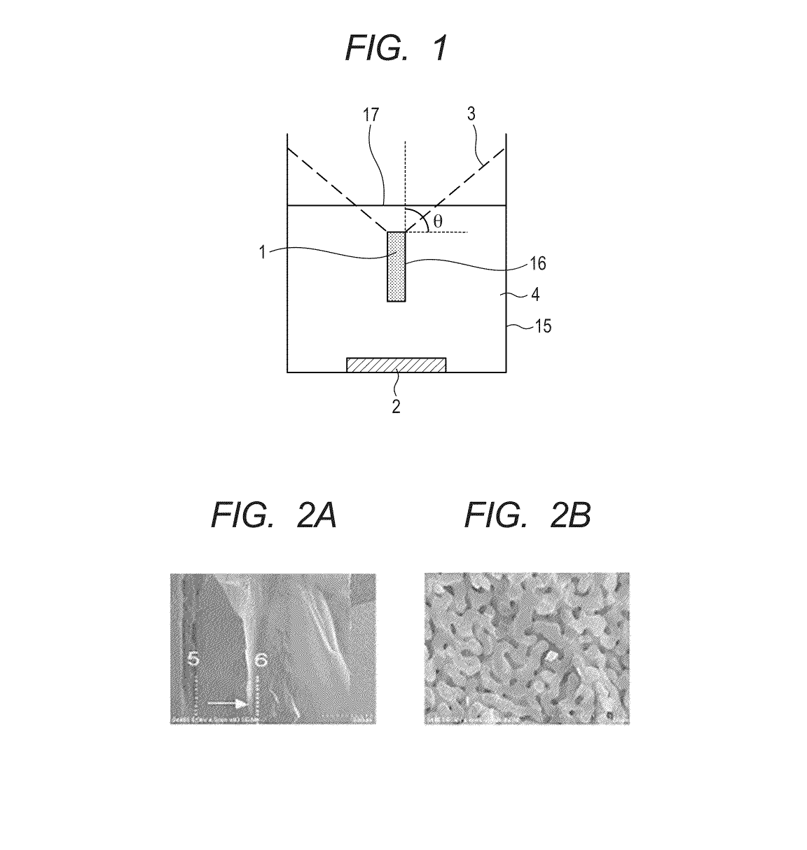

FIG. 1 is a schematic view illustrating one embodiment of a method of producing a porous glass according to the present invention. The method of producing a porous glass according to the present invention is a method for selective etching to porosify a phase-separated glass 1, in which the etching includes: immersing the phase-separated glass 1 in a bath 15 containing an acid solution 4; setting an angle θ, which is formed by a surface 16 to be porosified of the phase-separated glass and a bath liquid surface 17, to 10° or more to 90° or less; and irradiating the bath with an ultrasonic wave from an ultrasonic wave source 2. The phase-separated glass 1 hanging on a wire 3 is immersed in the acid solution 4. It is preferred to irradiate the bath with an ultrasonic wave from an ultrasonic wave source for generating the ultrasonic wave placed on a bottom of the bath.

The above-mentioned configuration can shorten a treatment time and provide a porous glass in which gel-like silica is suppressed from remaining and being deposited in pores of a porous portion. Although the mechanism is not clear, the following is considered.

In order to accelerate the etching treatment of a phase-separated glass, it is preferred that the acid solution in the vicinity of a glass surface be a pure and unreacted acid solution, i.e., be free of a by-product after the reaction at all times. Then, the following is considered. When an ultrasonic wave is applied to the vicinity of the surface of a phase-separated glass, the solution in the vicinity of the surface of the phase-separated glass is provided with a vibration, the reacted acid solution undergoes convection, and the unreacted acid solution flows in the vicinity of the glass surface. Further, a substance that forms a soluble phase portion flows out of pores after the reaction. In this case, when an ultrasonic wave is parallel (the angle θ is 90°) to the surface of the phase-separated glass, an eluted substance is removed every time it comes to the surface. On the other hand, it is considered that, when an ultrasonic wave is perpendicular (the angle θ is 0°) to the surface, the flow of the eluted substance is prevented, and gel-like silica remains and is deposited.

In the irradiation with an ultrasonic wave, an irradiation source is placed on either a bottom surface or a wall surface of a bath of an acid solution. Irrespective of whether the bath is irradiated from any surface, a glass may be irradiated with an ultrasonic wave from various directions due to the reflection from the wall surface of the bath and the like. Thus, as long as the phase-separated glass surface to be selectively etched with priority is not substantially parallel to the bath liquid surface, that is, the angle θ, which is formed by the surface 6 to be porosified with priority of the phase-separated glass and the bath liquid surface 7, is 10° or more (90° or less), preferably 45° or more (90° or less), more preferably 60° or more (90° or less), the glass surface may be irradiated with an ultrasonic wave from a direction parallel to the glass surface to accelerate etching.

Further, in the case where the surface to be porosified with priority of the phase-separated glass is placed so as to be substantially parallel to the liquid surface of the bath and to be opposed to each other, gravity may inhibit eluted gel-like silica from being flown out of pores and the gel-like silica may be are deposited and remain in the glass. In order to prevent this, it is preferred that the angle θ° formed by the surface to be porosified with priority of the phase-separated glass and the liquid surface be 10° or more to 90° or less.

The oscillating frequency and output power for the irradiation with may be those which are used in general ultrasonic cleaners. It is preferred that the irradiation with an ultrasonic wave to be carried out at an oscillating frequency of 28 kHz or more to 200 kHz or less and an output power of 100 W or more to 2,000 W or less. When the output power is less than 100 W, the practical removal effect is degraded, and when the output power exceeds 2,000 W, the risk of breakage increases. Further, at an ultrasonic wave having a frequency of the order of megahertz (MHz), a precipitate with a pore size of about 10 nm to 100 nm cannot be removed. Further, when the frequency is less than 28 kHz, there is a high risk that damage occurs when the output power is 100 W.

An acid solution for etching is hydrochloric acid, sulfuric acid, phosphoric acid, or nitric acid, in which a glass is immersed to dissolve a silica-poor phase. The concentration of the acid solution is 0.1 mol/L or more to 5 mol/L or less (0.1 to 5 N), preferably 0.5 mol/L or more to 2 mol/L or less (0.5 to 2 N). If required, in order to adjust a reaction speed and a holding function on the surface, the treatment temperature of the surface layer can be set in a range of −5° C. to 90° C.

It is preferred that, after immersing in an acid solution, a porous glass be rinsed with water for the purpose of removing an acid adhering to the porous glass and a soluble layer remaining without being eluted.

The porous structure of a glass obtained after the surface modified layer is removed and the selective etching is completed can be confirmed by an observation procedure such as SEM or a pore distribution measurement such as a mercury press-in method.

A glass having pores formed by the method of producing a glass according to the present invention has a spinodal structure based on silicon oxide. The phase separations are classified into a spinodal type and a binodal type. The pores of a porous glass obtained by a spinodal-type phase separation are penetrating pores linked from the surface to the inside as shown in FIG. 2B, for example. The structure in which the skeleton of a silicon oxide main component is continuously formed as shown in FIG. 2B is referred to as “spinodal structure based on silicon oxide”. The penetrating pores linked from the surface to the inside are formed by the spinodal structure based on silicon oxide. A binodal-type phase separation provides a structure having closed pores. It has been well known that pore sizes and their distribution can be controlled depending on conditions for the heat treatment during the production of the glass. Of the phase separation phenomena, the spinodal-type phase separation that provides a porous structure having penetrating pores linked from the surface to the inside, i.e., the so-called spinodal structure is preferred.

The average pore size of the porous glass, which is not particularly limited, desirably falls within the range of 1 nm to 1 μm, particularly 2 nm to 0.5 μm, further particularly 10 nm to 0.1 μm. The glass desirably has a porosity of generally 10 to 90%, particularly 20 to 80%.

The shape of the glass having pores formed therein is not particularly limited, and the glass is, for example, a membrane-like molded body of a tubular or plate-like shape. Those shapes can be appropriately selected depending on, for example, the applications of the glass.

The glass having pores formed therein is expected to find use in applications such as adsorbents, microcarriers, separation membranes, and optical materials because its porous structure can be uniformly controlled and its pore sizes can each be changed within a certain range.

Next, examples of the present invention are described.

Hereinafter, the present invention is described more specifically by way of examples, but the present invention is not limited to the following examples.

### Production Examples 1 to 3 of phase-separated glass

In order to show Examples and Comparative Examples of the present invention, a phase-separated glass was produced with the composition in terms of oxide as shown in Table 1. As material compounds of silicon, boron, sodium, and aluminum, silica powder (SiO₂), boron oxide (B₂O₂), sodium carbonate (Na₂CO₃), and alumina (Al₂O₂) were used, respectively. The mixed powder of the respective material compounds was placed in a platinum crucible and melted at 1500° C. for 24 hours. After that, the temperature was lowered to 1300° C., and the resultant was poured into a graphite mold. The mold was cooled in air for 20 minutes to obtain a borosilicate glass. A block of the borosilicate glass thus obtained was cut to 40 mm×30 mm×13 mm, and both surfaces were polished to mirror finish. The glass thus processed was subjected to phase separation treatment in an electric furnace under each of the conditions shown in Table 2.

TABLE 1

| Glass name | SiO₂ wt % | B₂O₃ wt % | Na₂O wt % | Al₂O₃ wt % |
|---|---|---|---|---|
| Production | 64 | 30 | 6 | — |
| Example 1 | | | | |
| Production | 65 | 27 | 8 | — |
| Example 2 | | | | |
| Production | 64 | 26 | 7 | 3 |
| Example 3 | | | | |

TABLE 2

| | Phase separation | Phase separation |
|---|---|---|
| | treatment | treatment |
| Glass name | temperature ° C. | time H |
| Production | 600 | 50 |
| Example 1 | | |
| Production | 600 | 50 |
| Example 2 | | |
| Production | 560 | 50 |
| Example 3 | | |

### Example 1

Glass etching was performed using the phase-separated glass of Production Example 1. A sample to be used was obtained by cutting the phase-separated glass to 15 mm×15 mm.

In etching with an acid, 50 g of 1 mol/L nitric acid were used as an acid solution. Nitric acid was placed in a container made of polypropylene, and the phase-separated glass hanging on a platinum wire was immersed so that an angle θ formed by the phase-separated glass surface and the liquid surface became 90° and the phase-separated glass was positioned at the center of the solution. The polypropylene container was covered and an ultrasonic wave was applied from a solution lower part. The applied ultrasonic wave had an ultrasonic wave output of 130 W and an oscillating frequency of 42 kHz. After the treatment for 2.5 hours, the glass etched with an acid was placed in water and rinsed for 90 minutes.

It was found by the observation with SEM that the range which was porosified was about 600 μm in a depth direction from the surface and the diameter of pores of the porous portion was about 100 nm. In addition, gel-like silica did not remain or was not deposited in the pores of the porous portion.

FIGS. 2A and 2B are electron micrographs of a fractured surface of the porous glass produced in Example 1. FIG. 2A is obtained by observing the entire fractured surface, and FIG. 2B is obtained by observing a local part of the porous portion.

### Example 2

The phase-separated glass of Production Example 1 cut to 15 mm×15 mm was used. In etching with an acid, 50 g of 1 mol/L nitric acid were used as an acid solution. Nitric acid was placed in a container made of polypropylene, and the phase-separated glass hanging on a platinum wire was immersed so that an angle θ formed by the phase-separated glass surface and the liquid surface became 10° and the phase-separated glass was positioned at the center of the solution. The polypropylene container was covered and an ultrasonic wave was applied from a solution lower part. The applied ultrasonic wave had an ultrasonic wave output of 130 W and an oscillating frequency of 42 kHz. After the treatment for 2.5 hours, the glass etched with an acid was placed in water and rinsed for 90 minutes.

It was that the range which was porosified was about 600 μm in a depth direction from the surface and the diameter of pores of the porous portion was about 100 nm. In addition, gel-like silica did not remain or was not deposited in the pores of the porous portion.

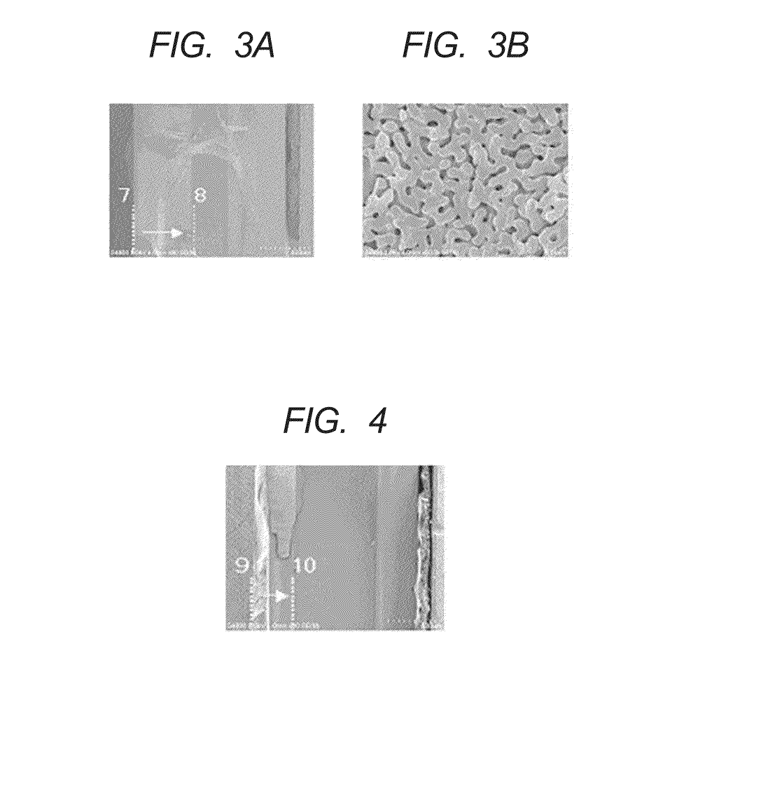

FIGS. 3A and 3B are electron micrographs of a fractured surface of the porous glass produced in Example 2. FIG. 3A is obtained by observing the entire fractured surface, and FIG. 3B is obtained by observing a local part of the porous portion.

### Example 3

Glass etching was performed using the phase-separated glass of Production Example 2. In the phase-separated glass, a surface modified layer was confirmed by SEM observation. The surface modified layer was found to have a thickness of about 200 nm by observation. Further, it was confirmed from XPS measurement that, compared with a cross-section, the surface of phase-separated glass was a layer having a smaller amount of boron and sodium and being occupied substantially with silicon. The surface modified layer was removed by polishing with cerium oxide.

Acid etching was performed while an ultrasonic wave applied so that an angle formed by the phase-separated glass surface and the liquid surface became 90° in the same way as in Example 1. The range which was porosified was about 500 μm in a depth direction from the surface and the diameter of pores of the porous portion was about 70 nm. In addition, gel-like silica did not remain or was not deposited in the pores of the porous portion.

### Example 4

Glass etching was performed using the phase-separated glass of Production Example 2. The modified layer was removed in the same way as in Example 3. Further, in the same way as in Example 2, the phase-separated glass hanging on a platinum wire was immersed so that an angle formed by the phase-separated glass surface and the liquid surface became 10° and the phase-separated glass was positioned at the center of the solution, and thus, acid etching was performed while an ultrasonic wave was being applied. It was found that the range which was porosified was about 500 μm in a depth direction from the surface and the diameter of pores of the porous portion was about 70 nm. In addition, gel-like silica did not remain or was not deposited in the pores of the porous portion.

### Example 5

Glass etching was performed using the phase-separated glass of Production Example 3. The formation of a modified layer having a thickness of about 100 nm on the surface was confirmed by SEM observation, and the modified layer was removed in the same way as in Example 3.

In the same way as in Example 1, acid etching was performed while an ultrasonic wave was applied so that an angle formed by the phase-separated glass surface and the liquid surface became 90°. It was found that the range which was porosified was about 600 μm in a depth direction from the surface and the diameter of pores of the porous portion was about 30 nm. In addition, gel-like silica did not remain or was not deposited in the pores of the porous portion.

### Example 6

Glass etching was performed using the phase-separated glass of Production Example 3. The modified layer was removed in the same way as in Example 3. Further, in the same way as in Example 2, the phase-separated glass hanging on a platinum wire to be immersed so that an angle formed by the phase-separated glass surface and the liquid surface became 10° and the phase-separated glass was positioned at the center of the solution, and thus, acid etching was performed while an ultrasonic wave was being applied. It was found that the range which was porosified was about 600 μm in a depth direction from the surface and the diameter of pores of the porous portion was about 30 nm. In addition, gel-like silica did not remain or was not deposited in the pores of the porous portion.

### Comparative Example 1

The phase-separated glass of Production Example 1 cut to 15 mm×15 mm was used. In etching with an acid, 50 g of 1 mol/L nitric acid were used as an acid solution. Nitric acid was placed in a container made of polypropylene, and the phase-separated glass hanging on a platinum wire was immersed so that an angle formed by the phase-separated glass surface and the liquid surface became 90° and the phase-separated glass was positioned at the center of the solution. The polypropylene container was covered and left to stand for 2.5 hours without ultrasonic wave application. The glass etched with an acid was placed in water and rinsed for 90 minutes.

It was found by SEM observation that the range which was porosified was about 350 μm in a depth direction from the surface, which was about a half of that of Example 1 in which an ultrasonic wave was applied. In addition, it was confirmed that gel-like silica remained in the pores of a porous portion. The diameter of the pores of the porous portion was about 100 nm.

FIG. 4 shows an SEM image of a fractured surface of the porous glass produced in Comparative Example 1, obtained by observing the entire fractured surface.

### Comparative Example 2

The phase-separated glass of Production Example 1 cut to 15 mm×15 mm was used. In etching with an acid, 50 g of 1 mol/L nitric acid were used as an acid solution. Nitric acid was placed in a container made of polypropylene, and the phase-separated glass hanging on a platinum wire was immersed so that an angle formed by the phase-separated glass surface and the liquid surface became 0° and the phase-separated glass was positioned at the center of the solution. The polypropylene container was covered and an ultrasonic wave was applied from a solution lower part. The applied ultrasonic wave had an ultrasonic wave output of 130 W and an oscillating frequency of 42 kHz. After the treatment for 2.5 hours, the glass etched with an acid was placed in water and rinsed for 90 minutes.

It was found by SEM observation that the range which was porosified was about 600 μm in a depth direction from the surface, and the etching depth had little difference from that of Example 1. In addition, it was confirmed that gel-like silica remained in the pores of a porous portion. The diameter of the pores of the porous portion was about 100 nm.

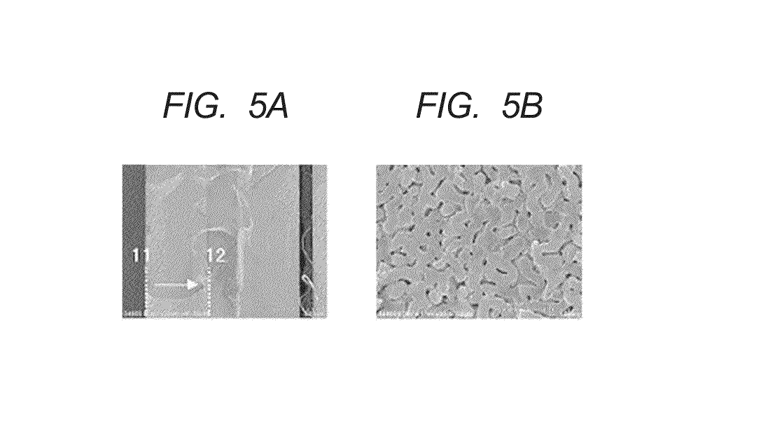

FIGS. 5A and 5B show SEM images of a fractured surface of the porous glass produced in Comparative Example 2. FIG. 5A is obtained by observing the entire fractured surface, and FIG. 5B is obtained by observing a local part of the porous portion.

### Comparative Example 3

Regarding the phase-separated glass of Production Example 2, acid etching was prepared and performed in the same way as in Comparative Example 1. The range which was porosified was about 300 μm in a depth direction from the surface, and it was confirmed that gel-like silica remained in the pores of a porous portion. The diameter of the pores of the porous portion was about 70 nm.

### Comparative Example 4

Regarding the phase-separated glass of Production Example 2, acid etching was prepared and performed in the same way as in Comparative Example 2. The range which was porosified was about 500 μm in a depth direction from the surface. In addition, it was confirmed that gel-like silica remained in the pores of a porous portion. The diameter of the pores of the porous portion was about 70 nm.

### Comparative Example 5

Regarding the phase-separated glass of Production Example 3, acid etching was prepared and performed in the same way as in Comparative Example 1. The range which was porosified was about 300 μm in a depth direction from the surface, and it was confirmed that gel-like silica remained in the pores of a porous portion. The diameter of the pores of the porous portion was about 30 nm.

### Comparative Example 6

Regarding the phase-separated glass of Production Example 3, acid etching was prepared and performed in the same way as in Comparative Example 2. The range which was porosified was about 600 μm in a depth direction from the surface, and it was confirmed that gel-like silica remained in the pores of a porous portion. The diameter of the pores of the porous portion was about 30 nm.

Table 3 shows, regarding Examples 1 to 6 and Comparative Examples 1 to 6, glass used, porosification depth in depth direction from surface which has been made porous glass after etching, pore size of portion which has been made porous, and existence of remaining of gel-like silica at porous portion.

TABLE 3

| | | Porosification | Pore size | Gel-like silica |
|---|---|---|---|---|
| | | depth in depth | of porous | remaining and |
| | | direction from | portion | deposited in |
| | Glass used | surface (μm) | (nm) | porous portion |
| Example 1 | Production | 600 | 100 | Absent |
| | Example 1 | | | |
| Example 2 | Production | 600 | 100 | Absent |
| | Example 1 | | | |
| Example 3 | Production | 500 | 70 | Absent |
| | Example 2 | | | |
| Example 4 | Production | 500 | 70 | Absent |
| | Example 2 | | | |
| Example 5 | Production | 600 | 30 | Absent |
| | Example 3 | | | |
| Example 6 | Production | 600 | 30 | Absent |
| | Example 3 | | | |
| Comparative | Production | 350 | 100 | Present |
| Example 1 | Example 1 | | | |
| Comparative | Production | 600 | 100 | Present |
| Example 2 | Example 1 | | | |
| Comparative | Production | 300 | 70 | Present |
| Example 3 | Example 2 | | | |
| Comparative | Production | 500 | 70 | Present |
| Example 4 | Example 2 | | | |
| Comparative | Production | 300 | 30 | Present |
| Example 5 | Example 3 | | | |
| Comparative | Production | 600 | 30 | Present |
| Example 6 | Example 3 | | | |

### INDUSTRIAL APPLICABILITY

The method of producing a porous glass according to the present invention enables porous glass containing no impurities in pores of a porous portion to be obtained, and a porous material to be produced at low cost because the method can shorten a treatment time. Then, the method of producing a porous glass according to the present invention can be used in the field of a low-density material and the field of a separating function material utilizing the characteristics of continuous holes.

While the present invention has been described with reference to exemplary embodiments, it is to be understood that the invention is not limited to the disclosed exemplary embodiments.

This application claims the benefit of Japanese Patent Application No. 2010-126329, filed Jun. 1, 2010, which is hereby incorporated by reference herein in its entirety.

1. A method of producing a porous glass, the method comprising:
immersing a phase-separated glass in a bath containing an acid solution;
setting an angle θ, which is formed by a surface to be porosified of the phase-separated glass and a bath liquid surface, to 10° or more to 90° or less; and
irradiating the bath with an ultrasonic wave to etch the phase-separated glass, thereby obtaining the porous glass.

2. The method according to claim 1, wherein the irradiating the bath with an ultrasonic wave is carried out with an ultrasonic wave source for generating the ultrasonic wave placed on a bottom of the bath.

3. The method according to claim 1, wherein a concentration of the acid solution is 0.1 mol/L or more to 5 mol/L or less.

4. The method according to claim 1, wherein the irradiating with an ultrasonic wave is carried out at an oscillating frequency of 28 kHz or more to 200 kHz or less and an output power of 100 W or more to 2,000 W or less.
